(19) United States
(12) Patent Application Publication
(10) Pub. No.: US 2009/0315339 A1
(43) Pub. Date: Dec. 24, 2009

(54) FITTING DOOR FURNITURE

(76) Inventor: Leonard Frank HIGHFIELD, Blandford Forum (GB)

Correspondence Address: HYRA IP, PLC, 12120 Sunset Hills Road, Suite 600, Reston, VA, 20190, US

(21) Appl. No.: 12/487,808

(22) Filed: Jun. 19, 2009

(30) Foreign Application Priority Data
Jun. 19, 2008 (GB) 08 11 275.7

(51) Int. Cl. E05B 15/02

(52) U.S. Cl. 292/2; 292/340

(57) ABSTRACT

A door latching system according to the invention is substantially conventional save in having a circular face plate (and corresponding striker plate) rather than the conventional rectangular form. A counterbore 34 of diameter D2 and depth T is drilled in the stile 10 of the door to receive the (circular) face plate. A bore 32 of diameter D1 and length L is drilled in the stile 10, concentric with the counterbore 34, to accommodate the body of the latch. Thus the latch is fitted with little or no chisel work.

### CROSS REFERENCE TO RELATED APPLICATIONS

This application claims priority from United Kingdom Patent Application No. 08 11 275.7, filed 19 June 2008, the entire disclosure of which is incorporated herein by reference in its entirety.

### BACKGROUND OF THE INVENTION

1. Field of the Invention

This invention relates to the fitting of door furniture and more particularly to the fitting of latches and locks to doors.

2. Description of the Related Art

A door latch or lock comprises a body with a retractable catch extending from one end. The catch is retractable by means of a handle, against the force of a spring held in the body, carried on a spindle extending through a stile of the door between and beyond the faces thereof. The body is secured in a cut-out formed in the stile so that the catch projects from the free edge thereof for engagement with a striker plate fixed to a jamb (sometimes known as a door lining). The jamb is formed with a recess to receive the catch and thereby hold the door closed until the catch is retracted.

A lock has additionally a bolt engageable with a second recess in the jamb to lock the door closed and retractable by means of a key to unlock the door. The present invention is, save for the need for an additional latch in the case of a lock, applicable to both latches and locks. For convenience hereinafter reference will be made only to latches, and references to latches should be deemed to embrace locks as well.

Forming the cut-out and the recess for a door latch is time-consuming and therefore expensive, for two reasons as follows. First, it is conventional for the cut-out and the recess to be rectangular, and although some material can be removed by drilling, the final forming requires skilled work with a chisel. Second, the cut-out and the recess must be precisely located in order for the door to close properly and hold closed without rattling.

It is an object of the present invention to reduce the time and cost of fitting a latch to a door.

### BRIEF SUMMARY OF THE INVENTION

Thus according to a first aspect of the invention there is provided a method of fitting a door latch having a body with a retractable catch extending from one end thereof through a circular face plate, wherein the method comprises forming a bore in a predetermined location in a stile of the door with a first drill of diameter D1 to circumscribe the body of the latch and forming a counterbore in the stile with a second drill of diameter D2, wherein D2 is greater than D1 and not less than the diameter of the face plate, and wherein said counterbore is concentric with said bore and of depth substantially equal to the thickness of the face plate.

Preferably said counterbore is formed before and defines the location of said bore.

The latch is preferably secured in the stile of the door by means of the face plate, which may be secured to the base of the counterbore by securing screws. Preferably the diameter of the face plate is equal to D2.

According to a second aspect of the invention there is provided apparatus for fitting a door latch according to the method set out above, which apparatus comprises a first drill of diameter D1 and a second drill of diameter D2, wherein the first drill is provided with a depth stop operative to define the depth of said bore and the second drill is provided with a depth stop operative to define the depth of said counterbore.

The apparatus for fitting a door latch according to the second aspect of the invention preferably comprises a template for defining the predetermined location of the bore and the counterbore.

The template preferably comprises a guide plate engageable with the stile of the door on the edge thereof and formed with a guideway for the second drill. The template may further comprise a side plate engageable with the stile of the door on a face thereof to locate the guideway at said predetermined location. The side plate and the guide plate may interconnect in first and second configurations alternatively defining said predetermined locations for door stiles of different thicknesses. To this end the side plate may be rotatable (that is, in use, turned end-to-end) relative to the guide plate to provide said first and second configurations respectively, and the side plate and the guide plate may conveniently interconnect by means of a dovetail. The side plate may define a predetermined location for a spindle of the latch, and possibly an alternative spindle location. The side plate may also define a predetermined location for a keyhole.

The template is preferably engageable with a jamb of the door to define a location for a striker plate.

According to a third aspect of the invention there is provided a door latching system for fitting by the method set out hereinbefore, wherein the system comprises a latch having a body received in said bore in the stile of the door and a face plate received in said counterbore in the stile of the door, and wherein the face plate is circular.

This door latching system may comprise a striker plate located on a jamb to cooperate with the latch, the jamb being drilled to provide a recess to receive a catch of the latch, and the striker plate being formed with a generally circular portion overlying said recess. The striker plate may also be formed with a tongue extending from said circular portion to an edge of the jamb to engage the catch of the latch and guide it into said recess.

### BRIEF DESCRIPTION OF THE SEVERAL VIEWS OF THE DRAWINGS

The invention will now be described by way of example only with reference to the accompanying schematic drawings, in which

FIG. 1 shows in isometric projection a conventional door latch fitted to a door as commonly known heretofore;

FIG. 2 shows in isometric projection a door latch embodying the invention;

FIG. 3 shows the door latch of FIG. 2 in front elevation;

FIG. 4 shows the door latch of FIG. 2 in end elevation;

FIG. 5 is a view corresponding to FIG. 4 bur with the latch removed;

FIG. 6 shows in end elevation a striker plate for the door latch of FIG. 2;

FIG. 7 illustrates the forming of a counterbore to accommodate the face plate of the latch shown in FIGS. 2 to 5;

FIG. 8 illustrates the forming of a bore to accommodate the body of the latch shown in FIGS. 2 to 5;

FIG. 9 is a simplified illustration, in isometric projection, of a template for fitting the latch of FIGS. 2 to 5 to a door;

FIG. 10 is plan view in cross section of the template of FIG. 9;

FIG. 11 is a front elevation of a template embodying the invention;

FIG. 12 shows in front elevation a plug for the template of FIG. 11; and

FIG. 13 shows the plug of FIG. 12 turned over.

### DESCRIPTION OF THE BEST MODE FOR CARRYING OUT THE INVENTION

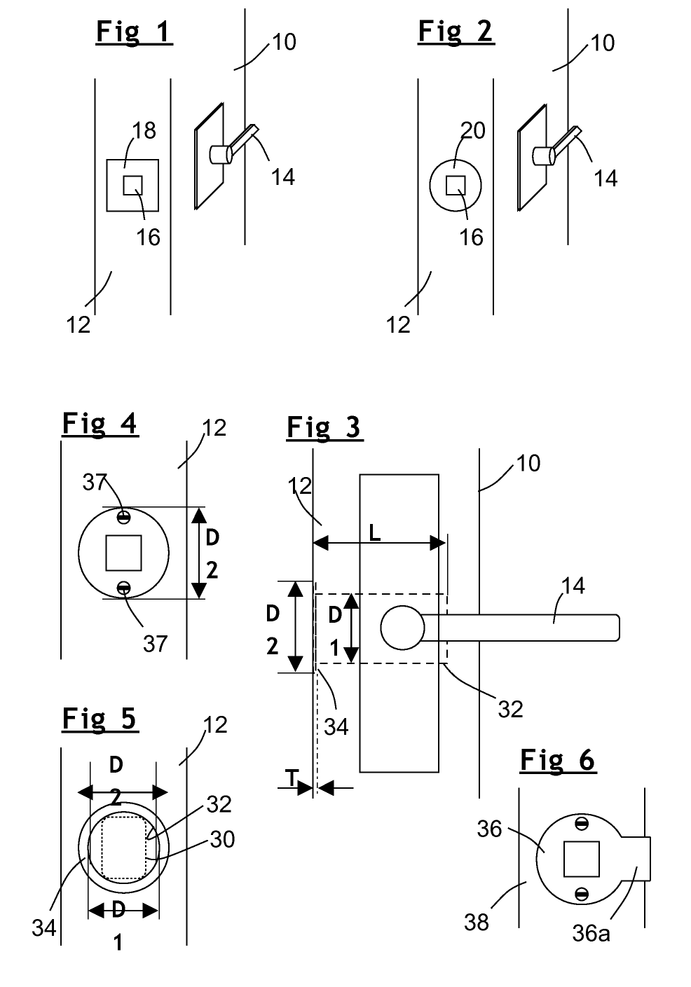

Referring first to FIG. 1, the conventional door latch shown therein is fitted into the stile 10 of a door. Its body (not detailed in the drawing) extends into the stile 10 from the free edge thereof and a handle 14 allows the catch 16 of the latch to be retracted against the action of a spring in the body. The catch 16 in use engages with a recess in a door jamb (not shown in FIG. 1) configured and arranged to cooperate with the stile 10, whereby the door is held closed until the handle 14 is operated to release the catch 16 from the recess. The body of the latch is generally rectangular and, in this conventional fitting, a rectangular hole is formed in the stile 10 to receive it. Similarly the latch has a face plate 18 which is generally rectangular and secured to the body of the latch, and a rectangular niched is formed in the edge 12 of the stile 10 to receive the face plate 18. Both the hole for the body and the niche for the face plate 18 require careful and time-consuming work with a chisel or the like.

In the arrangement of FIG. 2, this chisel work is avoided, and a good deal of time thereby saved. Yet the only visible difference is that the face plate 20 of FIG. 2 is circular rather than rectangular. (Since the face plate and the striker plate are concealed when a door is closed, it follows that the difference between the new circular form and the old rectangular form will be barely perceived, and both form may be used in one building without adverse visual impact).

More detailed differences in the arrangement according to the invention are apparent from FIGS. 3 to 5. The body of the latch is essentially conventional (so the invention does not call for a new design of latch body) and has a generally rectangular cross section, indicated in dotted lines at 30 in FIG. 5. This rectangular body fits snugly within a circumscribing bore 32 of diameter D1 extending into the stile 10 from its free edge 12. A counterbore 34 of diameter D2, greater than D1, also extends from the free edge 12 of the stile 10, concentric with the bore 32. The counterbore 34 accommodates the face plate 20, which is itself of diameter D2, and screws 37 are screwed into the base of the counterbore 34 to secure the face plate 20 (and hence the body 30 attached to it) within the stile 10. Those skilled in the art will appreciate that, because the bore 32 and the counterbore 34 are each circular in section, they may be readily formed by drilling or the like, so the fitting of the latch as shown in FIGS. 3 to 5 does not require time-consuming chisel work.

As shown in FIG. 6, a striker plate 36 for use with the latch of FIGS. 3 to 5 may also be fitted in a door jamb 38 with little or no chisel work. The striker plate 36 is generally circular (and of diameter D2) and is received in a counterbore like that for the face plate 20 but with the addition of a short channel to one side to accommodate the tongue 36a of the striker plate 36. This channel may be formed quickly and easily by use of a chisel, or it may readily be formed by other means such as routing.

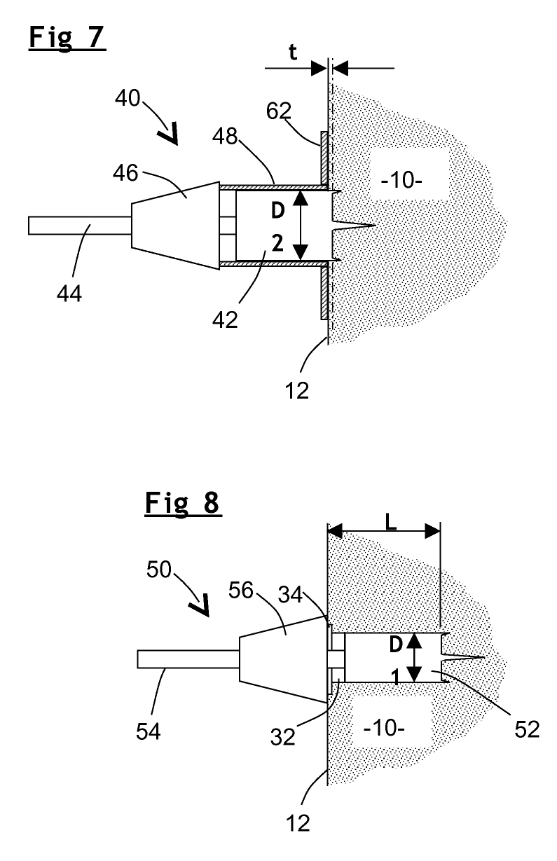

A drill 40 for forming the counterbore for both the face plate 20 and the striker plate 36 is shown in FIG. 7. The drill 40 has a spade bit 42 of working diameter D2. Its stem 44 carries a collar 46 which in use engages a tubular sleeve 48 of internal diameter D2. The collar 46 and sleeve 48 interact in use to provide a depth stop for the drill 40, such that the penetration of the bit 42 into the free edge 12 of the stile 10 is limited to a depth t, which is substantially equal to the thickness of the face plate 20 (FIG. 4). Thus the drill 40 can be used to form a counterbore to fit the face plate 20. The striker plate 36 (FIG. 6) has the same thickness, T, as the face plate 20, so the drill 40 can be used in the same way to form a counterbore in the doorjamb 38 to fit the striker plate 36.

A drill 50 for forming the bore to receive the body 30 of the latch is shown in FIG. 8. The drill 50 has a spade bit 52 of working diameter D1 and its stem 54 carries a collar 56. The collar 56 provides a depth stop for the drill 50 such that the bit 52 penetrates the free edge 12 of the stile 10 to a depth L, which is sufficient to accommodate the latch body 30 (FIG. 5).

When forming the stile 10 to accommodate the latch, the drill 40 is first used to form the counterbore 34. The bit 42 has a tip 42a that serves to provide a pilot hole centred in the counterbore 34. The drill 50 is used after the counterbore has been formed. The bit 52 has a tip 52a which is entered into the pilot hole left by the tip 42a, and by this means the counterbore 34 and the bore 32 are concentric.

It remains necessary to ensure that the latch components are properly located, and means for doing this are illustrated in FIGS. 9 to 13.

Referring first to FIG. 9, this shows a template 60 for fitting the latch to the stile 10. The template comprises a guide plate 62 which is use is engaged with the free edge 12 of the stile 10. The sleeve 48 (see also FIG. 7) is secured to and extends forward from the guide plate 62, thereby to provide a guideway for the counterbore drill 40 (FIG. 7). A side plate 64 is secured to the guide plate 62, orthogonally thereto, and in use the side plate 64 is engaged with the face of the stile 10 to provide a side stop for the template 60, whereby the sleeve 48 is located at a predetermined position across the free edge 12 of the stile 10.

The side plate 64 is also formed with a guide hole 66 defining a position for a hole to be bored through the stile 10 to receive a spindle for the operating handle of the latch.

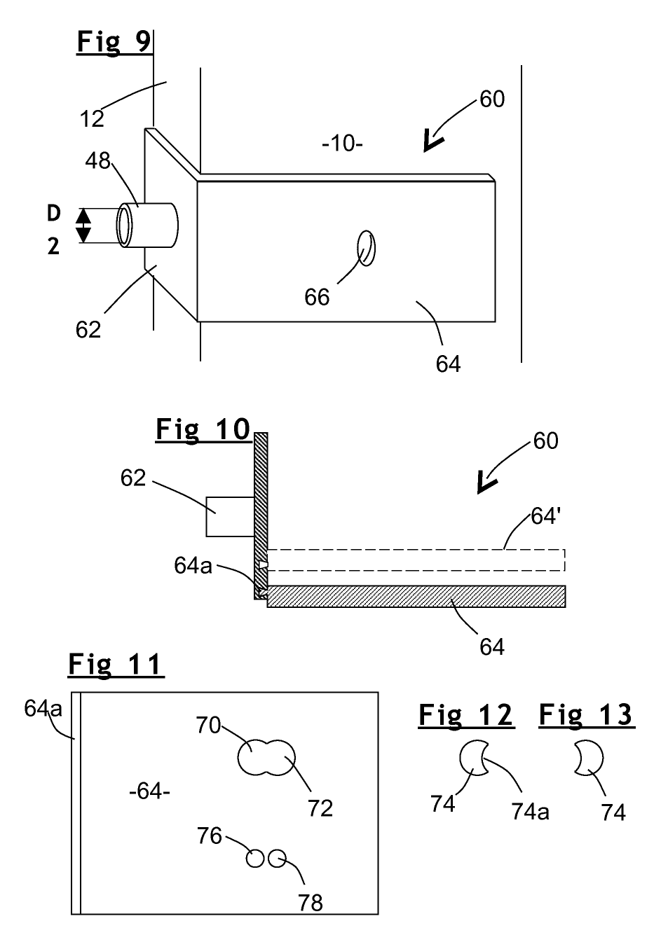

Normally, of course, latches are fitted halfway across the free edge 12 of the stile 12. There is some degree of standardisation in door dimensions, but nevertheless stiles may be of differing thicknesses. It follows that adjustment may be required to locate the latch properly. Convenient means for this is shown in FIG. 10. The side plate 64 is shown to have a dovetail connection with the guide plate 62, and the dovetail 64a is off-centre with respect to the side plate 64. Thus the stop provided by the side plate 64 may be easily adjusted by turning it over. Alternatively, or as well, the side plate may be moved to another dovetail, as indicated ghosted at 64′.

It will be understood that the template 60 may be used to locate the position of a striker plate by engaging it with a door jamb 38 or with other parts of a door casing as appropriate.

The utility of the template 60 may be further increased as illustrated by FIGS. 11 to 13. In place of the single guide hole 66 shown in FIG. 9, the side plate 64 may be formed with two guide holes 70 and 72 respectively to locate spindle holes for latch bodies of two differing lengths. Research has revealed that, for the commonest latch bodies, the holes 70 and 72 overlap, as shown on FIG. 11. Thus the invention also provides a plug 74 (FIGS. 12 and 13) to fit into the unwanted hole. If the hole 72 is at the correct location for a certain latch, the plug 74 orientated as indicated in FIG. 12 is fitted into the hole 70 so that the arc 74a completes the circumference of the hole 72. If the hole 70 is at the right location, the plug 74 is turned over, as indicated in FIG. 13, and fitted into the hole 72, completing the circumference of that. The plug 74 is a press fit in each of the holes 70 and 72, so that it will stay in place during use.

Also shown in FIG. 11, the side plate 64 may be formed with guide holes 76 and 78 for alternative keyhole positions.

Those skilled in the art will now appreciate that the present invention provides
(a) A method of fitting a door latch which saves time by use of drills rather than chisels;
(b) A door latching system configured and arranged to make use of the drilling method of fitting; and
(c) A template whereby the latch may be located quickly, easily and accurately.

The invention uses a latch which is conventional save insofar as it has a circular face plate rather than a rectangular one. This change requires only minimal change to the latch manufacturing process, because face plates are simply stamped. Having a circular face plate (and a corresponding striker plate) makes fitting quicker and easier, and also avoids the risk of breakout through the side of a stile (or jamb) which sometimes happens when fitting by means of a chisel.

Those skilled in the art will be well able to determine appropriate dimensions for the various elements of the invention. For commonly available latches, appropriate drill dimensions are D1=22 mm and D2=28 mm. A 16 mm diameter drill may be used for the handle spindle and the striker recess. However the invention is not limited to specific dimensions, and various modifications may be made to the described arrangement without departing from the scope of the invention.

1. A method of fitting a door latch having a body with a retractable catch extending from one end thereof through a circular face plate, wherein the method comprises forming a bore in a predetermined location in a stile of the door with a first drill of diameter D1 to circumscribe the body of the latch and forming a counterbore in the stile with a second drill of diameter D2, wherein D2 is greater than D1 and not less than the diameter of the face plate, and wherein said counterbore is concentric with said bore and of depth substantially equal to the thickness of the face plate.

2. A method of fitting a door latch as claimed in claim 1 wherein said counterbore is formed before and defines the location of said bore.

3. A method of fitting a door latch as claimed in claim 1 wherein the latch is secured in the stile of the door by means of the face plate.

4. A method of fitting a door latch as claimed in claim 3 wherein the face plate is secured to the base of the counterbore by securing screws.

5. A method of fitting a door latch as claimed in claim 1 wherein the diameter of the face plate is equal to D2.

6. Apparatus for fitting a door latch according to the method of claim 1, which apparatus comprises a first drill of diameter D1 and a second drill of diameter D2, wherein the first drill is provided with a depth stop operative to define the depth of said bore and the second drill is provided with a depth stop operative to define the depth of said counterbore.

7. Apparatus for fitting a door latch as claimed in claim 6 wherein said apparatus comprises a template for defining the predetermined location of the bore and the counterbore.

8. Apparatus for fitting a door latch as claimed in claim 7 wherein the template comprises a guide plate engageable with the stile of the door on the edge thereof and formed with a guideway for the second drill.

9. Apparatus for fitting a door latch as claimed in claim 8 wherein the template comprises a side plate engageable with the stile of the door on a face thereof to locate the guideway at said predetermined location.

10. Apparatus for fitting a door latch as claimed in claim 9 wherein the side plate and the guide plate interconnect in first and second configurations alternatively defining said predetermined locations for door stiles of different thicknesses.

11. Apparatus for fitting a door latch as claimed in claim 10 wherein the side plate is rotatable relative to the guide plate to provide said first and second configurations respectively.

12. Apparatus for fitting a door latch as claimed in claim 10 wherein the side plate and the guide plate interconnect by means of a dovetail.

13. Apparatus for fitting a door latch as claimed in claim 9 wherein the side plate defines a predetermined location for a spindle of the latch.

14. Apparatus for fitting a door latch as claimed in claim 13 wherein the side plate defines an alternative spindle location.

15. Apparatus for fitting a door latch as claimed in any of claims 9 to 17 wherein the side plate defines a predetermined location for a keyhole.

16. Apparatus for fitting a door latch as claimed in claim 9 wherein the template is engageable with a jamb of the door to define a location for a striker plate.

17. A door latching system for fitting by the method of claim 1, wherein the system comprises a latch having a body received in said bore in the stile of the door and a face plate received in said counterbore in the stile of the door, and wherein the face plate is circular.

18. A door latching system as claimed in claim 17, wherein the system comprises a striker plate located on a jamb to cooperate with the latch the jamb being drilled to provide a recess to receive a catch of the latch, and wherein the striker plate is formed with a generally circular portion overlying said recess.

19. A door latching system as claimed in claim 18, wherein the striker plate is formed with a tongue extending from said circular portion to an edge of the jamb to engage the catch of the latch and guide it into said recess.
